(19) United States
(12) Patent Application Publication
(10) Pub. No.: US 2014/0373040 A1
(43) Pub. Date: Dec. 18, 2014

(54) METHOD AND DEVICE FOR PROVIDING CONTENT/SERVICE SUBSCRIPTION AND PROVIDING SUBSCRIBED CONTENT/SERVICE

(71) Applicant: miiiCasa Taiwan Inc., Taipei City (TW)

(72) Inventors: CHIH-CHIANG LIN, New Taipei (TW); YU-HSIANG WANG, New Taipei (TW); CHI-MING LUO, New Taipei (TW)

(21) Appl. No.: 14/475,578

(22) Filed: Sep. 3, 2014

Related U.S. Application Data
(63) Continuation-in-part of application No. 13/760,575, filed on Feb. 6, 2013.
(60) Provisional application No. 61/873,757, filed on Sep. 4, 2013.

(51) Int. Cl. H04N 21/4363; H04N 21/258; H04N 21/436; H04N 21/418; H04N 21/441

(52) U.S. Cl. CPC H04N 21/43637; H04N 21/4182; H04N 21/441; H04N 21/43615; H04N 21/43607; H04N 21/25816
USPC 725/25

(57) ABSTRACT

The present disclosure provides a method, a system, an electronic device and a portable device for providing contents from content providers by identifications pre-stored in an external device attached to an object. A portable device implemented with the method or the system of the present invention obtains the identification from the external device, especially when the portable device is located in a specific region around the object so that the portable device can communicably connect to the external device. An electronic device implemented with the method or the system of the present invention receives the identification from the portable device and sends the identification to a management center. The management center verifies the identification and generates a confirmation corresponding to the identification and sends the confirmation to the electronic device. The electronic device then obtains the content by sending the confirmation to the content provider.

### CROSS-REFERENCE TO RELATED APPLICATIONS

This application claims priority to U.S. Patent Provisional Application Ser. No. 61/873,757, filed on Sep. 4, 2013, and claims priority to U.S. patent application Ser. No. 13/760,575, filed on Feb. 6, 2013, both of which are incorporated by reference herein in their entireties.

### FIELD OF THE INVENTION

The present invention relates generally to a method and a system for providing contents/services in television (TV) and internet service field, especially for over-the-top (OTT) services and internet of things (IOT) services. The present invention provides subscription for contents/services via a portable device and provides subscribed contents/services via an electronic device, wherein the portable device and the electronic device may be separated or be integrated into one device. The aforementioned portable electronic device may be any portable device that has input means for receiving identification of contents/services and communication means for transmitting said identification to a smart TV, and the aforementioned electronic device may be any electronic device that has communication means for receiving said contents/services and output said contents/services to an external display, such as a TV.

### BACKGROUND OF THE INVENTION

In recent years, internet services are prevailing over many application fields and changing user's behavior for accessing contents including photo, music, video, multimedia streaming data, application program, web services or any specific formatted documents. An emerging type of service is over-the-top service (OTT) which is generally not offered by the network operator. Content or services are provided without requirement of business or technology affiliations with network operators. It provides user broaden choices for accessing more and more contents or services. In addition, OTT services may be provided over various networks, such as the internet, communication networks or TV broadcasting networks, and on various devices, such as smart phone, tablet computers, desktop computers or other devices with network access. Recently, OTT services on televisions or similar devices are emerging due to the visual-comfort nature of devices with large screen size and home-sharing nature of living room devices. The term “large screen size” is only for describing the screen sizes that may be larger than the average screen sizes of portable electronic devices.

Usually, OTT services are provided on a platform built upon the network system and subscribed via a portal provided on the platform. The portal usually contains at least a list of OTT services for selection and subscription. Generally, category and search mechanism are also provided on the portal for users to access OTT services in a more convenient and accurate way. However, presentation and access of contents or services for users are also limited to the only portal in aforementioned conventional service model. Content providers and service providers need to compete with each other for a better presentation and access on aforementioned portal. As a result of such competition, some of contents or services may be never presented and accessed to users. Choices for contents and services for users may also be limited by the conventional service model.

According to the above, what is needed is a method or a device using such method for providing additional sources for users to subscribe contents/services and content providers to provide subscribed contents/services.

### BRIEF SUMMARY OF THE INVENTION

The invention provides a method and a system for a content provider providing identification of content or service for promotion or sale, and for verifying the user who received the identification to provide corresponding contents or services through an electronic device connecting to an external device with large screen size, such as a television. More specifically, the identification may be provided in an automatic identification symbol, an identification tag/chip for wireless transmission or a peripheral device having storage for the identification. Therefore, the method and the system of the present invention may be provided as an internet of things (IOT) service.

The invention provides a method in an electronic device, such as a set-top box, a TV tuner or a peripheral smart device of TV (an android stick, a chromecast or an apple TV), for receiving identification of content or service received from a portable device like a smart phone or tablet computer, verifying the identification by transmission the identification to a management center and receiving a confirmation and an index or a content address for content or service, retrieving the content or service by the index or the address and outputting the content or service to a display for displaying the content or service. Therefore, OTT services subscribed through any portable devices may be provided through the electronic device implemented with the method of the present invention.

The invention also provides a method in an portable device, such as a smart phone, a tablet computer, a laptop computer, an electronic book reader, a multimedia player, a wireless access point and a femtocell, for receiving identification of content or service received from an external device or an automatic identification symbol, verifying the identification and providing contents or services corresponding to the identification by transmission the identification to an management center via an electronic devices. The management center will confirm the identification and provide an index or a content address of content or service. The content or service may be provided to the user of the portable device by the index or the address through electronic device. Therefore, OTT services may be subscribed as IOT services by collecting the identification of said OTT services through the portable devices implemented with the method of the present invention.

The invention also provides a method in a management center, for receiving a request for default content from an electronic device, sending the default content to the electronic device, receiving an identification via the electronic device from an external device connected to a portable device, which is connected to the electronic device, confirming the identification and sending a confirmation and an index or an address of the content to the electronic device. The index or the address may direct the user to the content or service provider of the requested content or service, and the identification of the content or service can be recognized by the content or service provider. Therefore, content or service will be provided to the user of the portable device in the electronic device by outputting the content or service to a display device connected to the electronic device.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIGS. 1A, 1B, 1C and 1D are network block diagrams of the portable device, electronic device, the management center and the content provider according to some embodiments of the present invention;

FIGS. 2A, 2B and 2C are flowcharts of the method for subscribing a content/service and providing the subscribed content/service according to one embodiment of the present invention;

FIGS. 3A and 3B are flowcharts of the method for subscribing a content/service via physical objects and providing the subscribed content/service as an internet-of-things service according to one embodiment of the present invention;

FIGS. 4A and 4B are schematic illustrations of the identification for verification according to one embodiment of the present invention;

FIGS. 5A, 5B, 5C and 5D are network block diagrams of the portable device, electronic device, the management center and the content provider according to some embodiments of the present invention;

FIGS. 6A, 6B, 6C and 6D are flowcharts of the method for subscribing a content/service and providing the subscribed content/service according to one embodiment of the present invention.

In accordance with common practice, the various described features are not drawn to scale and are drawn to emphasize features relevant to the present disclosure. Like reference characters denote like elements throughout the figures and text.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

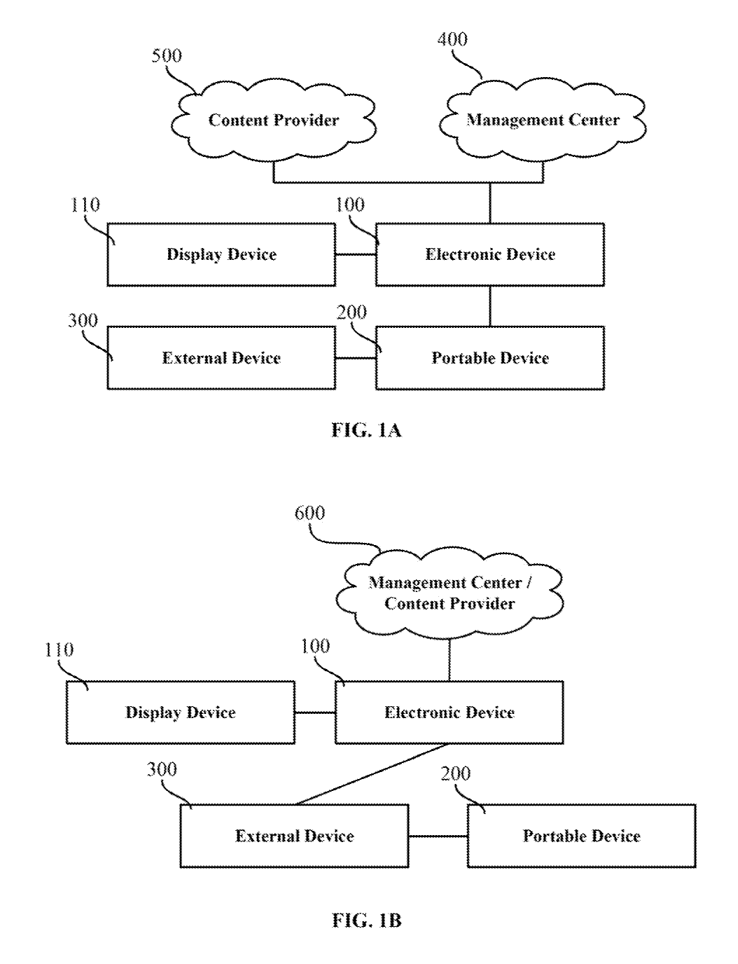

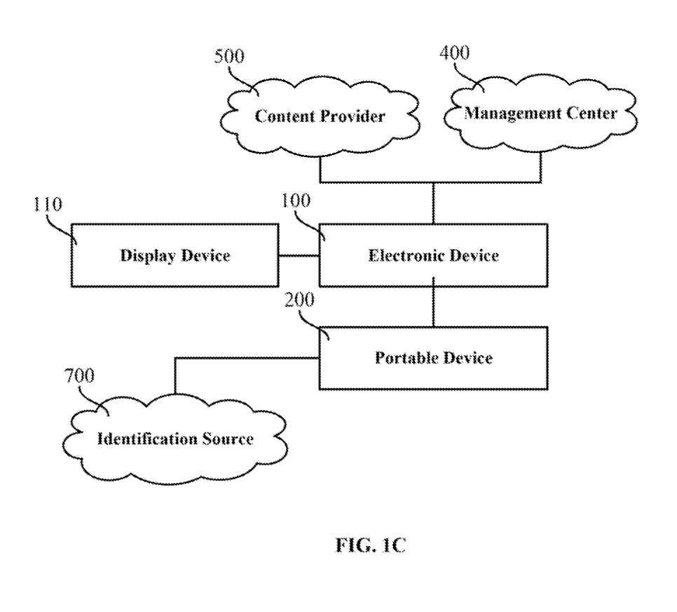

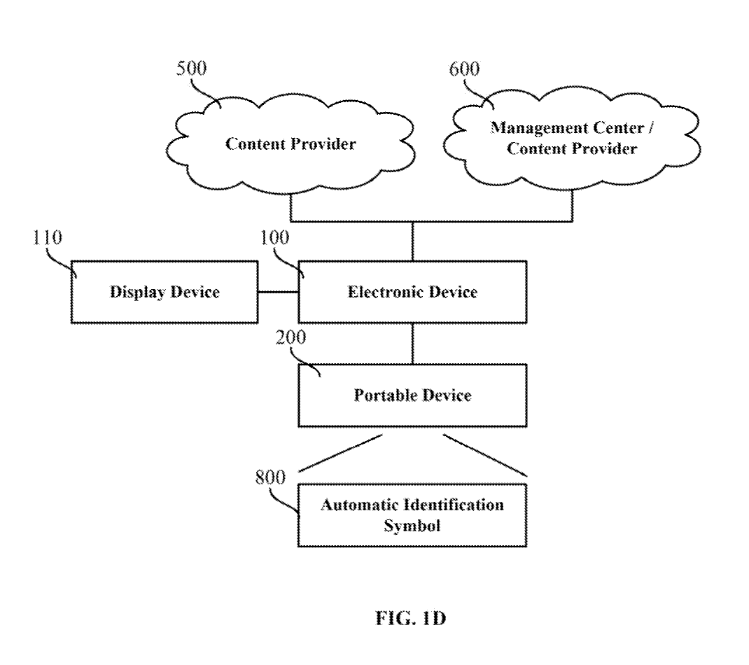

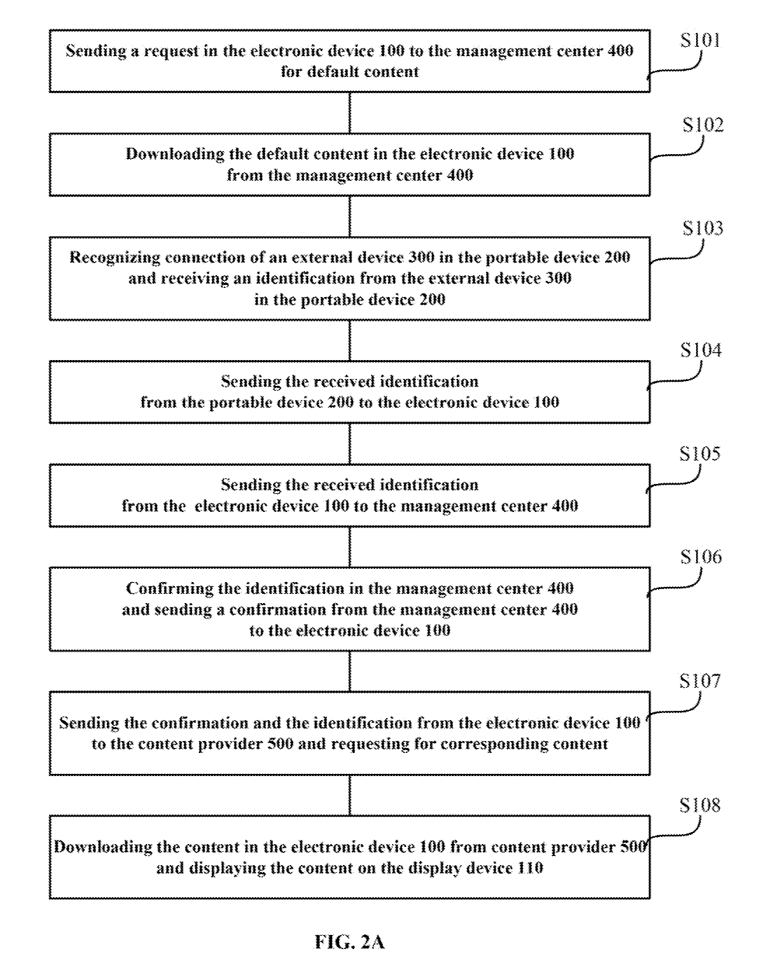

The description will be made as to the embodiments of the present invention in conjunction with the accompanying drawings in FIGS. 1A-6D. Reference will be made to the drawing figures to describe the present invention in detail, wherein depicted elements are not necessarily shown to scale and wherein like or similar elements are designated by same or similar reference numeral through the several views and same or similar terminology.

One embodiment of the present invention provides a portable device for subscribing contents/services by receiving a content/service identification from an external device, an automatic identification symbol or a content/service identification source (hereinafter the “portable device”), a management center for verifying subscription to contents/services by confirming received identification and an electronic device for providing the subscribed contents/services on a display device (hereinafter the “electronic device”), wherein the portable device and the electronic device may be integrated into one device or be two separate devices. For example, the present invention includes embodiments that are illustrated in FIGS. 1A-6D.

FIGS. 1A, 1B, 1C and 1D illustrate the network architecture of the system for subscribing contents/services with identification, verifying subscription by the identification and providing subscribed contents/services according to some embodiments of the present invention.

Referring to FIG. 1A, the external device 300 may include a storage unit for storing an identification of content/service and a connector for connecting to the portable device 200. The portable device 200 may comprise a reader for reading the identification from the external device 300 via the connector of the external device 300. The portable device 200 may further comprise a communication module for transmitting the received identification to the electronic device 100. The electronic device 100 may comprise at least one communication module for receiving the identification from the portable device 200, sending the identification to the management center 400 to verify the identification, receiving a confirmation from the management center 400 and providing the confirmation and/or the identification to the content provider 500 to request for the content/service corresponding to the identification, receiving the content/service from the content provider 500 and transmitting the content/service to the display device 110. The management center 400 may maintain a database of identifications for comparing to the received identification to determine whether the received identification is valid. In addition, the management center 400 may further record subscription of the identification and check whether received identifications have already been subscribed to avoid repeated subscription. The management center 400 may send a confirmation to the electronic device 100 if the identification is valid and/or not repeatedly subscribed. The electronic device 100 may send a request for the content/service to the content provider 500. The address of the content provider 500 for content/service may be contained in the identification or the confirmation, or be stored in the electronic device 100. In one embodiment, the management center 400 may send the confirmation to the content provider 500 instead of the electronic device 100 and direct the electronic device 100 to the address of the content provider 500 for content/service corresponding to the identification. The content provider 500 may receive the confirmation from the electronic device 100 or the management center 400 and transmit data of the content/service to the electronic device 100 in response to the content/service request from electronic device 100. A person of ordinary skill in the art will realize that the management center 400 may also be the content provider 500 in some embodiments of the present invention so that the management center 400 may provide the content/service directly to the electronic device 100 after verifying the identification instead of sending the confirmation for the electronic device 100 downloading the content/service from the content provider 500.

Referring to FIG. 1B, the external device 300 may include a storage unit, a connector and a communication module to communicate with the electronic device 100. The portable device 200 may be able to communicate with the electronic device 100 when the external device 300 is connected to the portable device 200 and acts like an add-on communication module of the portable device 200 applying a communication standard compatible to the electronic device 100. The identification of content/service may be transmitted directly from the external device 300 to the electronic 100. The electronic device 100 may be configured to receive the identification from the portable device 200, send the identification to a management center providing contents 600 (hereinafter “the management center/content provider 600”) the management center/content provider 600 to verify the identification, receive the content/service from the management center/content provider 600 and provide the content/service corresponding to the identification via the display device 110. The management center/content provider 600 may act as a combination of the aforementioned management center 400 and the aforementioned content provider 500. Therefore, the management center/content provider 600 may maintain a database of identifications for comparing to the received identification to determine whether the received identification is valid. In addition, the management center/content provider 600 may further record subscription of the identification and check whether received identifications have already been subscribed to avoid repeated subscription. After confirmed validity and/or subscription of the identification, the management center/content provider 600 may provide content/service corresponding to the identification to the electronic device 100.

Referring to FIG. 1C, the portable device 200 may comprise at least one communication module for downloading the identification from an identification source 700 via the internet and sending the identification to the electronic device 100. The electronic device 100 may comprise at least one communication module and be configured to receive the identification from the portable device 200, send the identification to the management center 400 to verify the identification, receive a confirmation from the management center 400 and provide the confirmation and/or the identification to the content provider 500 to request for the content/service corresponding to the identification, receive the content/service from the content provider 500 and transmit the content/service to the display device 110. The management center 400 may determine whether the received identification is valid. In addition, the management center 400 may further record subscription of the identification and decide whether received identifications have already been subscribed to avoid repeated subscription. The management center 400 may send a confirmation to the electronic device 100 if the identification is valid and/or has not been subscribed. The electronic device 100 may send a request for the content/service to the content provider 500. In one embodiment, the management center 400 may send the confirmation to the content provider 500 instead of the electronic device 100 and may direct the electronic device 100 to the address of the content provider 500 for content/service corresponding to the identification. The content provider 500 may receive the confirmation from the electronic device 100 and transmit data of the content/service to the electronic device 100 in response to the content/service request from electronic device 100.

Referring to FIG. 1D, the portable device 200 may comprise a receiving module for receiving, analyzing and/or decoding an automatic identification symbol, such as a barcode, an a radio frequency identification (RFID) tag, or an equipment comprising a near field communication (NFC) or Bluetooth module, containing the aforementioned identification corresponding to the content/service. The portable device 200 may also comprise a communication module for sending the identification to the electronic device 100. The electronic device 100 may also comprise a communication module for receiving the identification from the portable device 200, sending the identification to the management center 400 to verify the identification, receiving a confirmation from the management center 400 and providing the confirmation and/or the identification to the content provider 500, receiving the content/service from the content provider 500 and transmitting the content/service to the display device 110. The management center 400 may send a confirmation to the electronic device 100 if the identification is valid and/or has not been subscribed. The electronic device 100 may send a request with the confirmation and/or the identification to the content provider 500. The content provider 500 may receive the confirmation and/or identification and transmit data of the content/service to the electronic device 100.

The contents or services of the present invention may comprise a multimedia file or streaming multimedia, a still image or an album of still images, e-book pages, video or audio broadcasting, text and web pages for providing web services. The contents or services may further be indexed as a channel in the electronic device 100, the portable device 200 and/or the management center 400. That is, the content or the services may be provided by the aforementioned devices by the channel indexes and the channel indexed. In one embodiment of the present invention, the electronic device 100, the electronic device 200 and management center 400 may maintain a channel list of contents or services and may synchronize the data in the channel lists to each other. In another embodiment, the content or the service may be assigned by the user of the electronic device 100 when the user logs into the management center 400.

The electronic device 100 of the present invention may also be any device having output interface for displaying content on the connected display device 110, wherein the output interface may be any video or audio interface for transferring data which can be implemented adopting customized protocols or following existing standards or de facto standards such as a High-Definition Multimedia Interface (HDMI), Video Graphics Array (VGA), DisplayPort, Thunderbolt, Lightning Bolt, Universal Serial Bus (USB). The output interface may be further including a customized connector or a standard connector such as HDMI connector, VGA connector, DisplayPort connector, Mini DisplayPort (MDP) connector, USB connector, Thunderbolt connector or Lightning connector. However, the output interface may also be implemented as a wireless chip adopting customized protocols or following existing wireless standards or de facto standards such as IEEE 802.11 series (Wireless Local Area Network, WLAN) including Wi-Fi series or Wireless Gigabit Alliance (WiGig) Standard, IEEE 802.11 series including Bluetooth®, Miracast, Digital Living Network Alliance (DLNA) Standard, Wireless Home Digital Interface (WHDI), WirelessHD standard, Wireless USB, WiDi developed by Intel®, Allshare developed by Samsung® or Airplay developed by Apple®. Moreover, the electronic device 100 of the present invention may have at least one communication module for transferring data to the display device 110, the management center 400 or the content provider 500 and receiving data from the portable device 200, the management center 400 or the content provider 500, wherein the communication module may be adopting customized protocols or following existing standards or de facto standards such as Ethernet, IEEE 802.11 or IEEE 802.15 series, Wireless USB or telecommunication standards such as GSM, CDMAone, CDMA2000, WCDMA, TD-SCDMA, WiMAX, 3GPP-LTE or TD-LTE. In one embodiment of the present invention, the electronic device 100 may comprise a first communication module for communicating with the portable device 200 and a second communication module for communicating with the management center 400 and the content provider 500. In some implementations, the first communication module and the second communication module may adopt different protocols. The electronic device 100 may be a set-top box, a TV tuner, a video recorder, an audio player, a game console, a media player, a signal amplifier device, projector, a router, a gateway, a wireless access point, a pico base station, a femtocell or a peripheral smart device of TV, such as an android stick or a chromecast which is developed by Google®.

The display device 110 of the present invention may be any devices with an interface for receiving content data and a display means for displaying contents, such as an external monitor for computing device, a television or a projecting device.

The portable device 200 of the present invention may be a smart phone, a tablet computer, a personal digital assistant (PDA), a laptop computer, an electronic book reader, a digital photo frame, a digital camera, a remote controller, a video recorder, an audio player, a game console, a media player, a signal amplifier device, a projector, a router, a gateway, a wireless access point, a pico base station, a femtocell or any wearable device.

The portable device 200 of the present invention may have a communication module for transferring data to the electronic device 100 and receiving data from the identification source 700 or the external device 300, wherein the communication module may be adopting customized protocols or following existing standards or de facto standards such as Ethernet, Universal Serial Bus (USB), IEEE 802.11 series (Wireless Local Area Network, WLAN) including Wi-Fi series or Wireless Gigabit Alliance (WiGig) Standard, IEEE 802.11 series including Bluetooth®, Miracast, Digital Living Network Alliance (DLNA) Standard, Wireless Home Digital Interface (WHDI), WirelessHD standard, Wireless USB, WiDi developed by Intel®, Allshare developed by Samsung® or Airplay developed by Apple®, or telecommunication standards such as GSM, CDMAone, CDMA2000, WCDMA, TD-SCDMA, WiMAX, 3GPP-LTE or TD-LTE. In one embodiment of the present invention, the portable device 200 may comprise a first communication module for communicating with the external device 300 and a second communication module for communicating with the electronic device 100. In some implementations, the first communication module and the second communication module may adopt different protocols. In another embodiment of the present invention, the portable device 200 of the present invention may have a physical interface for transferring to and receiving data from to the external device 300, wherein the physical interface may be an earphone jack or other connecter adopting customized protocols or following existing standards or de facto standards such as Universal Serial Bus (USB), IEEE 1394, memory card connecter etc. The external device 300 may comprise a communication module so that the portable device 200 may transmit data to the electronic device 100 and receive data from the identification source 700 via the external device 300 instead of having a communication module itself The portable device 200 of the present invention may also have an automatic identification sensor for receiving identification from automatic identification symbol 800, such as a bar code, an RFID tag and equipment with near field communication (NFC) or Bluetooth module. Therefore, the automatic identification sensor may be an image capturing device with barcode identification module, an RFID reader, an NFC module or a Bluetooth module.

Moreover, in some embodiments, the portable device 200 may be replaced by the electronic device 100. That is, the electronic device 100 may receive the identification by connecting to the external device 300, identification source 700 or receiving from the automatic identification symbol 800, such as a barcode, an a radio frequency identification (RFID) tag, or an equipment comprising a near field communication (NFC) or Bluetooth module.

The external device 300 of the present invention may be any device with a storage configured to store an identification of content or service and a connector or communication module for transmitting the identification to the portable device 200. Therefore, external device 300 may be implemented in any form or implemented as any existing objects adding aforementioned storage and connector/communication on, such as a toy with a USB drive, a dongle of smart phone with a earphone connector, . . . etc. The aforementioned storage may include ROM, RAM, EPROM, EEPROM, hard disk, solid state drive, soft disk, CD-ROM, DVD-ROM or other forms of electronic, electromagnetic or optical recording medium. The aforementioned connector may include an earphone connector, a USB connector or connectors adopting customized protocols or following other existing standards or de facto standards. In another embodiment of the present invention, the external device 300 may be an assembly of said storage device, said communication module (or said connector) and an attachment mechanism for attaching to the existing objects such as a toy, a book or a package of a commercial product. In some implementations, the identification stored in the external device 300 is corresponding to content related to the aforementioned existing objects such as a video related to the aforementioned toy, an audio book version of the aforementioned book or a promotion material related to the aforementioned commercial product.

The management center 400, the content provider 500, the management center/content provider 600 or the identification source 700 of the present invention may be a server, a server cluster or data center with a web address or URL for visiting via the electronic device 100 or the portable device 200.

The automatic identification symbol 800 of the present invention may comprise a carrier with image on said carrier, wherein the identification may be encoded in the image with automatic identification encoding algorithm, such as 1-dimension or 2-dimension barcode encoding algorithm. The portable device 200 with a camera module and a corresponding decoder may retrieve the image and analyze the image to get the identification decoded from the image. The automatic identification symbol 800 of the present invention may also include a wireless module for transmitting the identification via radio frequency, such as radio frequency identification (RFID), IEEE 802.15.4 (ZigBee), near field communication (NFC) or Bluetooth.

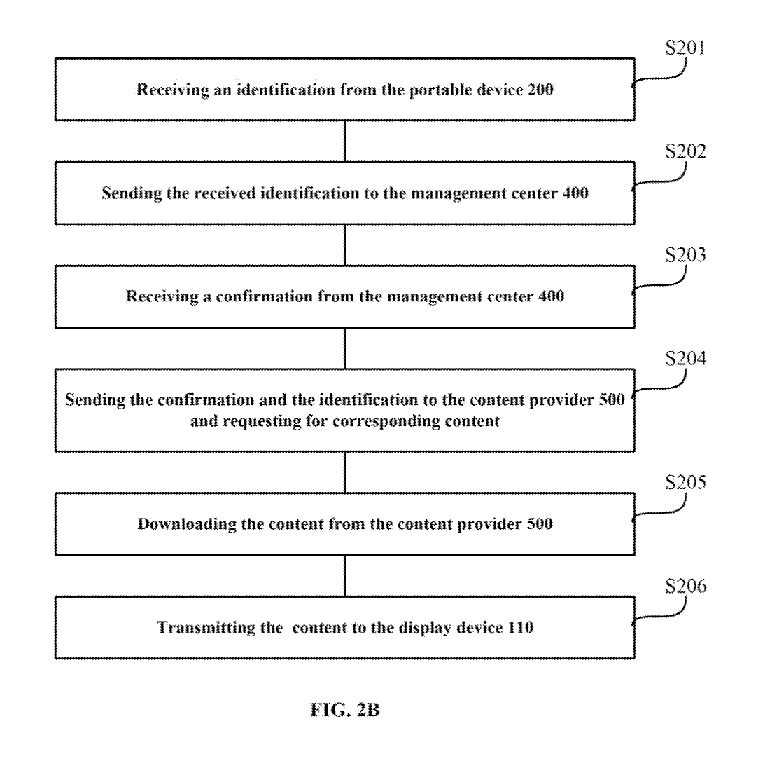

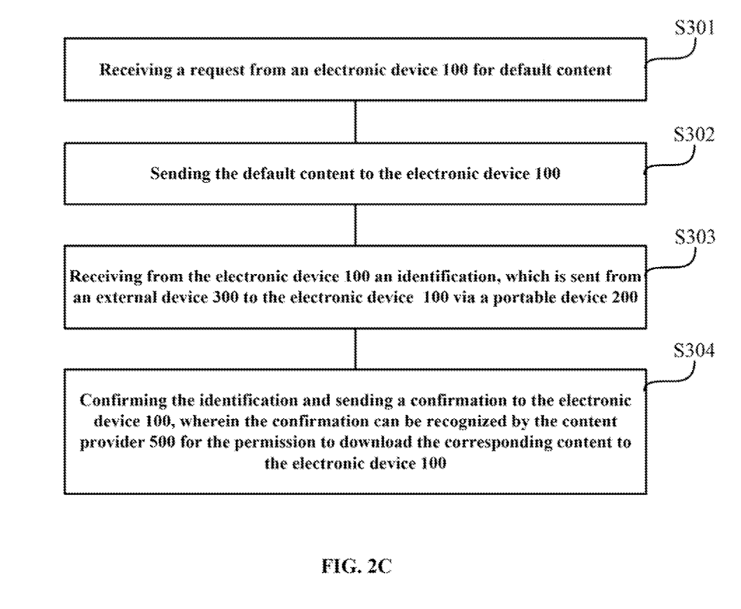

FIGS. 2A, 2B and 2C are flowcharts illustrating the method for receiving identification of content/service from the external device 300, verifying the identification by transmitting the identification to the management center 400 and receiving a confirmation and an address or an index for content/service, retrieving the content/service by the address or the index and outputting the content/service to the display device 110 according to one embodiment of the present invention. The method of the present invention may be applied on the electronic device 100 and/or the management center 400 of the present invention respectively.

FIG. 2A illustrates the method for receiving default content/service, subscribing to new content/service by an identification received from the external device 300 and receiving the subscribed content/service according to one embodiment of the present invention, and the method of present invention may perform the following steps.

In step S101, the electronic device 100 may a request for default content/service to the management center 400. In one embodiment, default content/service may not be installed in the electronic device 100 when the electronic device 100 leaves the factory. The address of the management center 400 may be stored in the electronic device 100 before it leaves the factory, and the electronic device 100 may be configured to request for default content/service once the electronic device 100 activated and connected to the internet. In step S102, the management center 400 may receive the request for default content/service and provide default address for download. The electronic device 100 may download the default content/service from the management center 400. In one embodiment, the management center 400 may also register the electronic device 100 by recording the electronic device 100 to a device database maintained by the management center 400. Therefore, by steps S101 and S102, the registration of the electronic device 100 and download of default content/service in the electronic device 100 may be accomplished. The default contents/services in the electronic device 100 may be provided and indexed as channels. That is, the contents/services may have a channel number respectively and may be retrieved by the corresponding channel number. The electronic device 100 may receive a channel number, such as “99”, and provide the content/service corresponding to “channel 99”.

In the present invention, new contents/services may also be provided to the electronic device 100 by providing identification for subscription of the aforementioned contents/services in the external device 300 of the present invention. Once the external device 300 connected to the portable device 200, content/service corresponding to the identification in the external device 300 may be provided by the management center 400 to the electronic device 100 as an internet-of-things (IOT) service through steps S103 to S108. In step S103, the portable device 200 may recognize connection of the external 300 and receive an identification corresponding to a new content/service from the external device 300. In step S104, the portable device 200 may send the identification to the electronic device 100. In step S105, the electronic device 100 may send the identification to the management center 400 and may further request for verification and/or subscription of the identification. In step S106, the management center 400 may confirm the identification by comparing the identification to an identification database to decide whether the identification is valid. If the identification is valid, the management center 400 may return a confirmation to the electronic device 100. In one embodiment, the confirmation may comprise an address or an index of the content/service for the electronic device 100 to download the content/service. In another embodiment, the aforementioned address or index of content/service may be contained in the identification instead of the confirmation, and the electronic device 100 may be configured to request for downloading the content/service after receiving the confirmation. In step S107, the electronic device 100 may send the confirmation and/or the identification to the content provider 500 for requesting for content/service corresponding to the identification by visiting the content/service address contained in the identification or the confirmation. In one embodiment of the present invention, the identification may tell the content provider 500 the content/service demanded from the electronic device 100, and the confirmation may be recognized by the content provider 500 for the content provider 500 to identify whether the electronic device 100 is verified by the management center 400 and subscribed to the requested content/service. In step S108, the content provider 500 may receive the identification and/or the confirmation and provide the corresponding content/service for downloading. The electronic device 100 may download the content/service from the content provider 500 and transmit the downloaded content/service to the display device 100 for displaying the content/service.

In one embodiment of the present invention, the content provider 500 may be continuously providing the aforementioned content/service to the electronic device 100 while the external device 300 connected to the portable device 200. Once the external device 300 disconnected with the portable device 200, the portable device may send a notification to the electronic device 100, and the electronic device 100 may stop downloading the content/service from the content provider 500.

While the methods previously described may include a number of steps that may appear to occur in a specific order, it should be appreciated that these methods may contain more or fewer steps, that the order these steps may be exchanged, and that different steps may be combined. For example, the steps S101 and S102 may be omitted.

FIG. 2B illustrates the method for subscribing to new content/service by an identification received from the portable device 200 and receiving the subscribed content/service according to one embodiment of the present invention. The method of the present invention may be applied on the electronic device 100, and may perform the following steps. In step S201, the electronic device 100 may receive an identification from the portable device 200. The identification may be retrieved from the external device 300, the identification source 700 or the automatic identification symbol by the portable device 200. In step S202, the electronic device 100 may send the identification received in step S201 to the management center 400 for verifying the identification. In step S203, after the management center 400 verifying the identification, the electronic device 100 may receive a confirmation from the management center 400. In one embodiment, the confirmation may comprise an address or an index of the content/service for the electronic device 100 to download the content/service. In another embodiment, the aforementioned address or index of content/service may be contained in the identification instead of the confirmation, and the electronic device 100 may be configured to request for downloading the content/service after receiving the confirmation. In step S204, the electronic device 100 may send the confirmation and the identification to the content provider 500 of the content/service corresponding to the identification. In step S205, after the content provider 500 verifying the confirmation and the identification, the electronic device 500 may download the content/service from the content provider 500. The content/service may be downloaded as a file, batch downloaded web pages or streaming data. In step S206, the electronic may transmit the content/service to the display device 110.

While the methods previously described may include a number of steps that may appear to occur in a specific order, it should be appreciated that these methods may contain more or fewer steps, that the order these steps may be exchanged, and that different steps may be combined. For example, the steps S205 and S206 may be performed concurrently, that is, the electronic device 100 may be continuously downloading the content/service and transmitting the downloaded content/service to the display device 110. In addition, after step S206, the electronic device 100 may receive a notification from the portable device 200 and stop transmitting the content/service to the display device 110.

FIG. 2C illustrates the method for providing default content/service and subscription of new content/service by an identification received from the electronic device 100 according to one embodiment of the present invention. The method of the present invention may be applied on the management center 400, and may perform the following steps. In step S301, the management center 400 may receive a request from the electronic device 100 for default content. The management center 400 may receive a default content identification from the electronic device 100 when the electronic device 100 is activated after leaving factory or reactivated after reset. Therefore, the management center 400 may further verify the default content identification by comparing to a database of identifications maintained in the management center 400 and determining whether the received default content identification is valid. In step S302, the management center may send the default content/service to the electronic device 100. In one embodiment, the management center 400 may also register the electronic device 100 by recording the electronic device 100 to a device database maintained by the management center 400. Therefore, by steps S301 and S302, the registration of the electronic device 100 and download of default content/service in the electronic device 100 may be accomplished. In step S303, the management center 400 may receive an identification for new content/service form the electronic device 100. The identification from the electronic device 100 may be retrieved by the portable device 200 from the external device 300 and sent to the electronic device 100. In other words, the identification from the electronic device 100 may be sent from the external device 300 to the electronic device 100 via a portable device 200. In one embodiment, the identification may be sent directly from the external device 300 to the electronic device 100 and sent to the management center by the electronic device 100. In step S304, the management center 400 may confirm the identification. In one embodiment, the management center 400 may maintain a database of identifications for comparing to the received identification to determine whether the received identification is valid. In addition, the management center 400 may further record subscription of the identification and check whether received identifications have already been subscribed to avoid repeated subscription. The management center 400 may send a confirmation to the electronic device 100 if the identification is valid and/or not repeatedly subscribed. The confirmation may be recognized by the content provider 400 for the permission to download the content/service corresponding to the identification and the confirmation from the content provider 500 to the electronic device 100. In one embodiment, an address of the content provider 500 for content/service may be contained in the identification or the confirmation, or be stored in the electronic device 100. In another embodiment, the management center 400 may send the confirmation to the content provider 500 instead of the electronic device 100 and direct the electronic device 100 to the address of the content provider 500 for content/service corresponding to the identification. The content provider 500 may receive the confirmation from the electronic device 100 or the management center 400 and transmit data of the content/service to the electronic device 100 in response to the content/service request from electronic device 100. A person of ordinary skill in the art will realize that the management center 400 may also be the content provider 500 in some embodiments of the present invention so that the management center 400 may provide the content/service directly to the electronic device 100 after verifying the identification instead of sending the confirmation for the electronic device 100 downloading the content/service from the content provider 500.

While the methods previously described may include a number of steps that may appear to occur in a specific order, it should be appreciated that these methods may contain more or fewer steps, that the order these steps may be exchanged, and that different steps may be combined. For example, the steps S301 and S302 omitted.

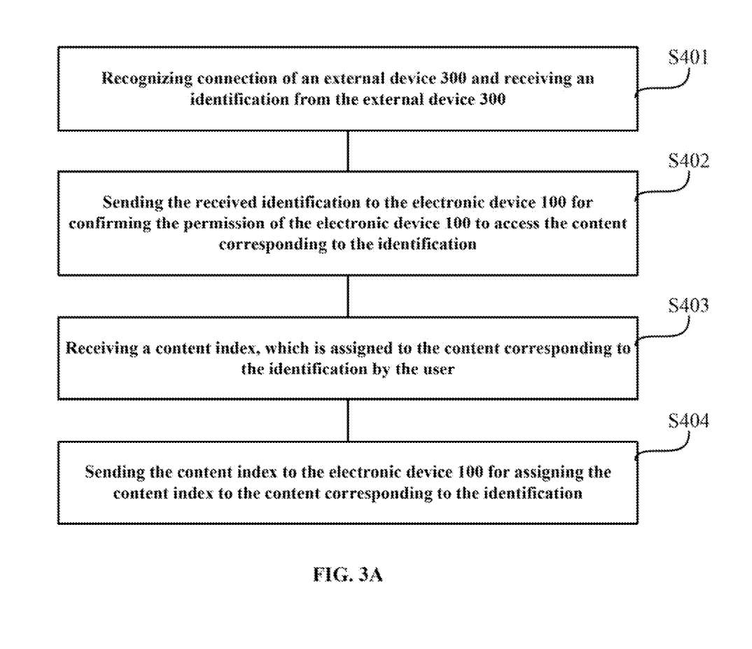

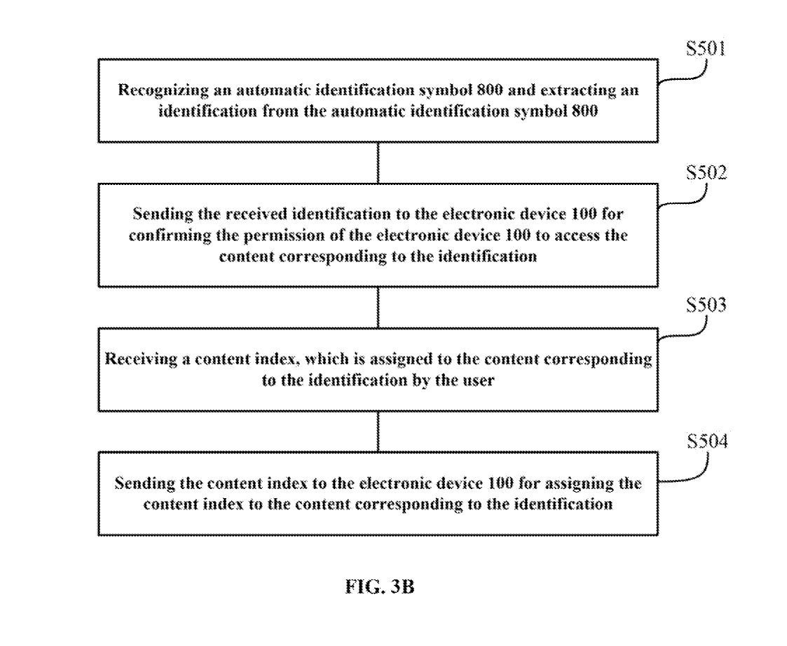

FIGS. 3A and 3B are flowcharts illustrating the method for receiving identification of content/service from the external device 300 or the automatic identification symbol 800, subscribing to the content/service and assigning a content index, such as a channel number, for the content/service corresponding to the identification according to one embodiment of the present invention. The method of the present invention may be applied on the portable device 200 of the present invention.

FIG. 3A illustrates the method for receiving identification of content/service from the external device 300 and subscribing to the content/service according to one embodiment of the present invention. The method of the present invention may be applied on the portable device 200, and may perform the following steps. In step S401, the portable device 200 may recognize connection of the external 300 and receive an identification corresponding to a new content/service from the external device 300. In step S402, the portable device 200 may send the identification to the electronic device 100 for subscribing to the content/service. The electronic device 100 may send the identification to the management center 400 and may receive the content information from the management center 400. The content information may comprise the name and the address of the content. The electronic device 100 may provide the received content information and a user interface for inputting content index to the user of the portable device 200 by displaying the content information and the user interface on the display device 110. In step S403, the portable device 200 may receive a content index from the user, which is assigned to the content/service corresponding to the identification by the user. The aforementioned content index may comprise numbers and/or characters, especially a number represent a TV channel when the electronic device 100 or the display device 110 is a television. In step S404, the portable device 200 may send the content index to the electronic device 100 for assigning the content index to the content/service corresponding to the identification. The electronic device 100 may record the content index and the content address and may access the content/service by the content address or provide the content/service every time the electronic device 100 receives the content index.

FIG. 3B illustrates the method for receiving identification of content/service from the automatic identification symbol 800 and subscribing to the content/service according to one embodiment of the present invention. The method of the present invention may be applied on the portable device 200, and may perform the following steps. In step S501, the portable device 200 may recognize an automatic identification symbol 800 and extract an identification for content/service from the automatic identification symbol 800, such as a barcode tag, an RFID tag, an NFC equipment or a Bluetooth equipment. In other words, the portable device may receive and analysis data in the automatic identification symbol 800 to get the identification. In step S502, the portable device 200 may send the identification to the electronic device 100 for subscribing to the content/service. The electronic device 100 may send the identification to the management center 400 and may receive the content information from the management center 400. The content information may comprise the name and the address of the content. The electronic device 100 may provide the received content information and a user interface for inputting content index to the user of the portable device 200 by displaying the content information and the user interface on the display device 110. In step S503, the portable device 200 may receive a content index from the user, which is assigned to the content/service corresponding to the identification by the user. The aforementioned content index may comprise numbers and/or characters, especially a number represent a TV channel when the electronic device 100 or the display device 110 is a television. In step S504, the portable device 200 may send the content index to the electronic device 100 for assigning the content index to the content/service corresponding to the identification. The electronic device 100 may record the content index and the content address and may access the content/service by the content address or provide the content/service every time the electronic device 100 receives the content index.

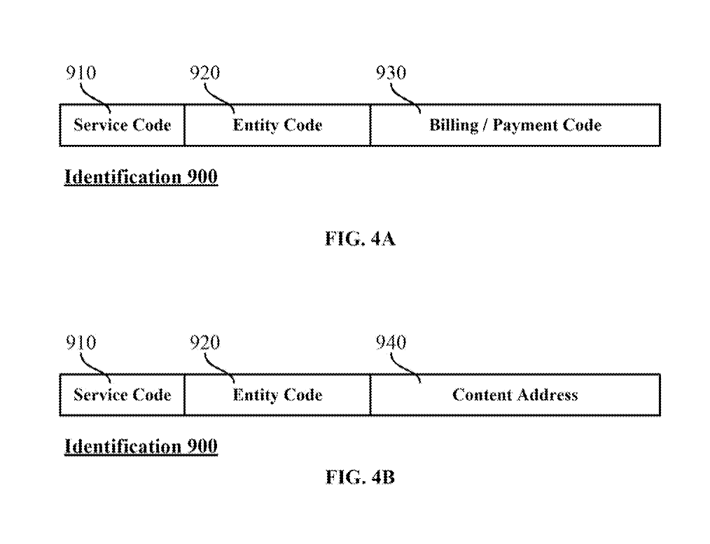

FIGS. 4A and 4B are schematic illustration of the identification for content/service according to one embodiment of the present invention. Referring to FIG. 4A, the identification 900 may comprise a service code 910 representing the content/service (or the type of the content/service), the entity code 920 representing the content provider 500 corresponding to the content/service and a billing/payment code 930 representing the billing and payment information for the content/service, such as prepaid money, discount and/or billing for the content/service. The identification may be encrypted in the external device 300, the automatic identification symbol 800 or the identification source 700, and may be decrypted by the electronic device 100, the management center 400 or the content provider 500 for verification and recognition of the corresponding content/service. The service code 910, the entity code 920 and the billing/payment code 930 may have their respective formats of data. The length of each code 910, 920 and 930 may be fixed, and the value of each code 910, 920 and 930 may be configured to be a number or a string. Therefore, the management center 400 may verify the identification 900 by the formats of the code 910, 920 and 930. In addition, the management center 400 may find the content/service and the corresponding provider by the service code 910 and the entity code 920 and compare to data in an identification database to decide whether the identification 900 is valid. In addition, the management center 400 may further record subscription of the identification and check whether received identifications have already been subscribed to avoid repeated subscription. In one embodiment, the management center 400 may further maintain the billing and the payment of the user account of the portable device 200 and/or the electronic device 100, such as refill the user account for the content/service, bill the user account for the content/service and offer a discount for the content/service. In another embodiment, the billing and the payment of the user account of the portable device 200 and/or the electronic device 100 may be maintained by the content provider 500 when the content provider 500 receives the identification 900. Referring to FIG. 4B, the identification 900 may include a content address 940 instead of the billing/payment code 930. The management center 400 may verify the validity and the subscription of the identification 900 and sent a confirmation to the electronic device 100. The electronic device 100 may be configured to access the content address 400 for the content/service upon receiving the confirmation.

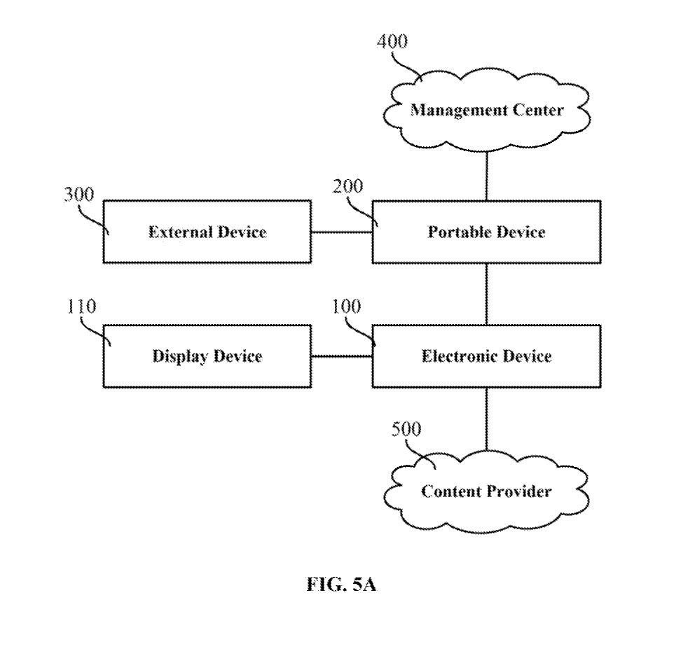

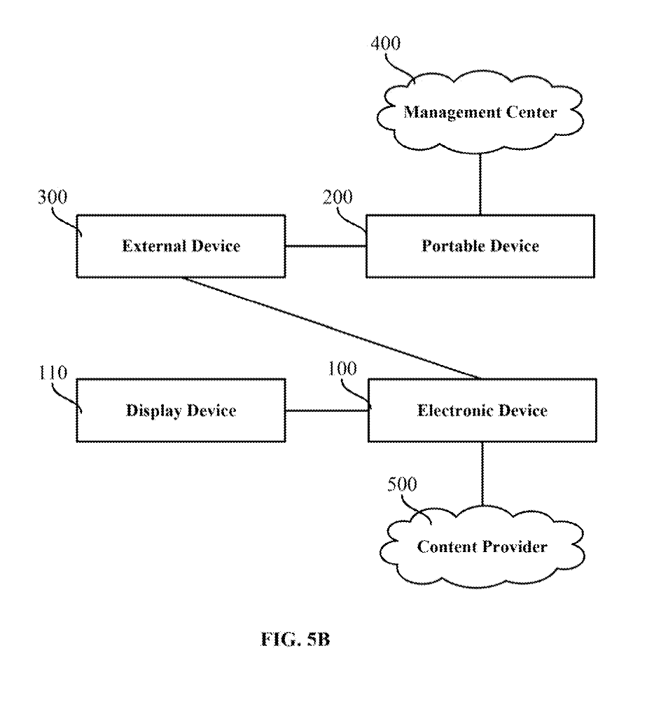

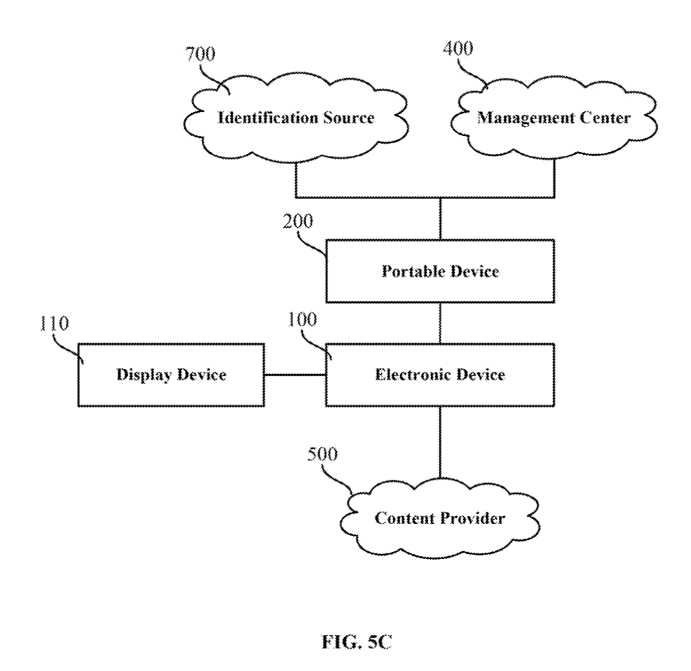

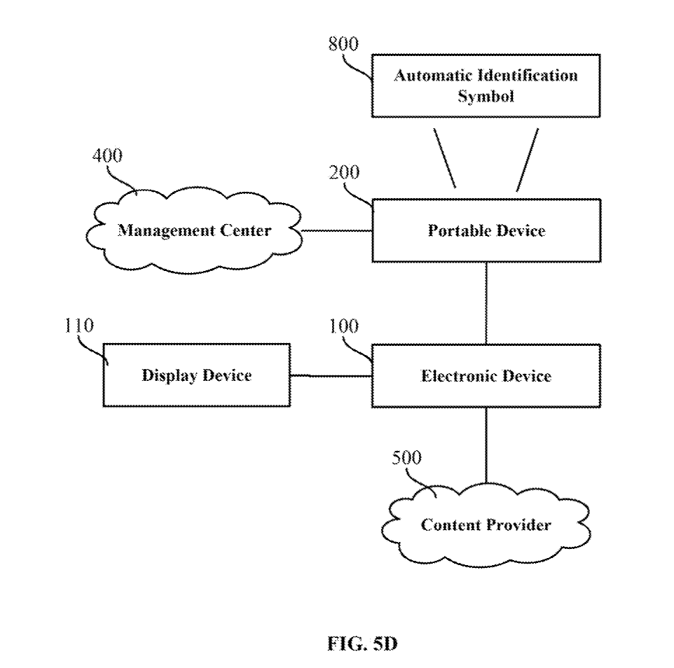

FIGS. 5A, 5B, 5C and 5D illustrate the network architecture of the system for subscribing contents/services with identification, verifying subscription by the identification and providing subscribed contents/services according to some embodiments of the present invention.

Referring to FIG. 5A, the external device 300 may include a storage unit for storing an identification of content/service and a connector for connecting to the portable device 200. The portable device 200 may comprise a reader for reading the identification from the external device 300 via the connector of the external device 300. The portable device 200 may further comprise a communication module for transmitting the received identification to the management center 400 to verify the identification, receiving a confirmation from the management center 400 and sending the confirmation and the identification to the electronic device 100 for requesting the content/service. The electronic device 100 may comprise at least one communication module for receiving the identification and confirmation from the portable device 200, sending the identification and confirmation to the content provider 500 to request for the content/service corresponding to the identification, receiving the content/service from the content provider 500 and transmitting the content/service to the display device 110.

Referring to FIG. 5B, the external device 300 may include a storage unit, a connector and a communication module to communicate with the electronic device 100. The portable device 200 may be able to communicate with the management center 400 via the internet and may be able to communicate with the electronic device 100 when the external device 300 is connected to the portable device 200 and acts as an add-on communication module of the portable device 200 applying a communication standard compatible to the electronic device 100. The portable device 200 may be configured to retrieve the identification from the external device 300 via the aforementioned connector, send the identification to the management center 400 to verify the identification and receive a confirmation from the management center 400. The portable device 200 may further send the identification and the confirmation to the electronic device 100 via the external device 300 for requesting the content/service. The electronic device 100 may comprise at least one communication module for receiving the identification and confirmation from the portable device 200, sending the identification and confirmation to the content provider 500 to request for the content/service corresponding to the identification, receiving the content/service from the content provider 500 and transmitting the content/service to the display device 110.

Referring to FIG. 5C, the portable device 200 may comprise at least one communication module for downloading the identification from an identification source 700, sending the identification to the management center 400, receiving a confirmation from the management center 400 and sending the confirmation and the identification to the electronic device 100. The electronic device 100 may comprise at least one communication module and be configured to receive the identification and the confirmation from the portable device 200, send the confirmation and/or the identification to the content provider 500 to request for the content/service corresponding to the identification, receive the content/service from the content provider 500 and transmit the content/service to the display device 110.

Referring to FIG. 5D, the portable device 200 may comprise a receiving module for receiving, analyzing and/or decoding an automatic identification symbol, such as a barcode, an a radio frequency identification (RFID) tag, or an equipment comprising a near field communication (NFC) or Bluetooth module, containing the aforementioned identification corresponding to the content/service. The portable device 200 may also comprise a communication module for sending the identification to the management center 400, receiving a confirmation from the management center 400 and sending the identification and the confirmation to the electronic device 100. The electronic device 100 may also comprise a communication module for receiving the identification and the confirmation from the portable device 200, sending the confirmation and/or the identification to the content provider 500, receiving the content/service from the content provider 500 and transmitting the content/service to the display device 110.

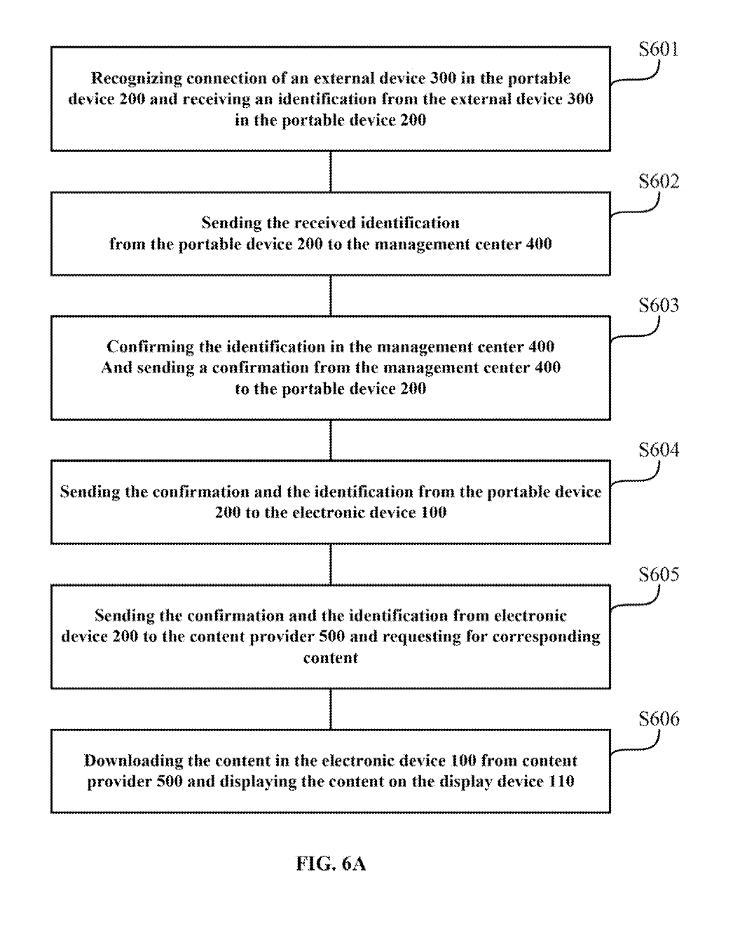

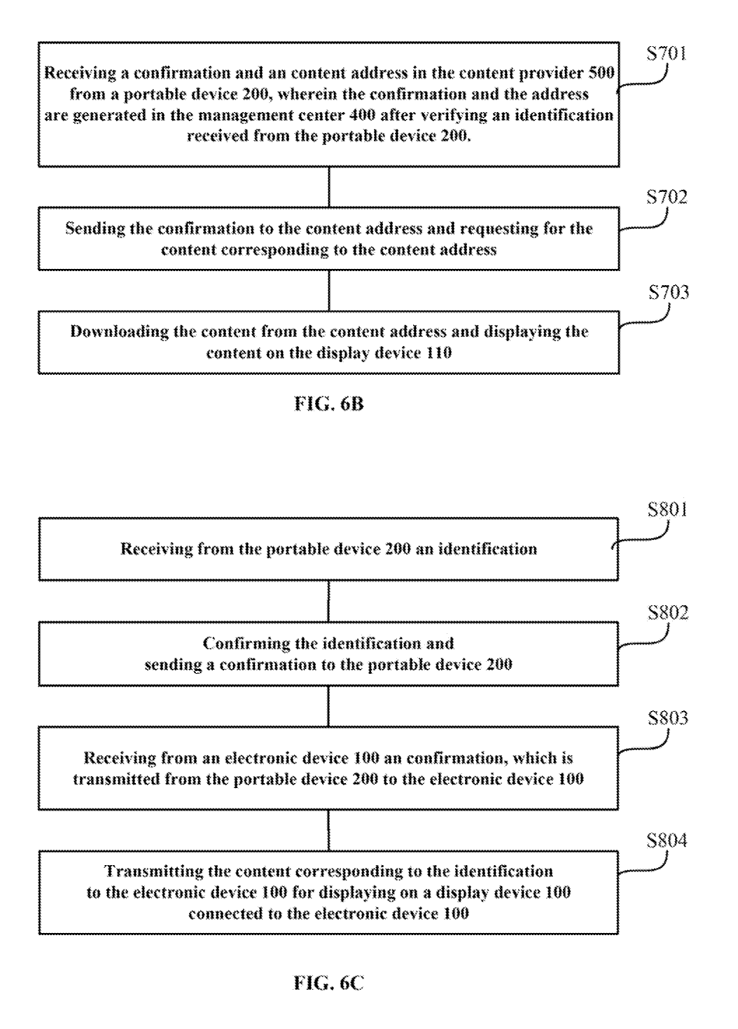

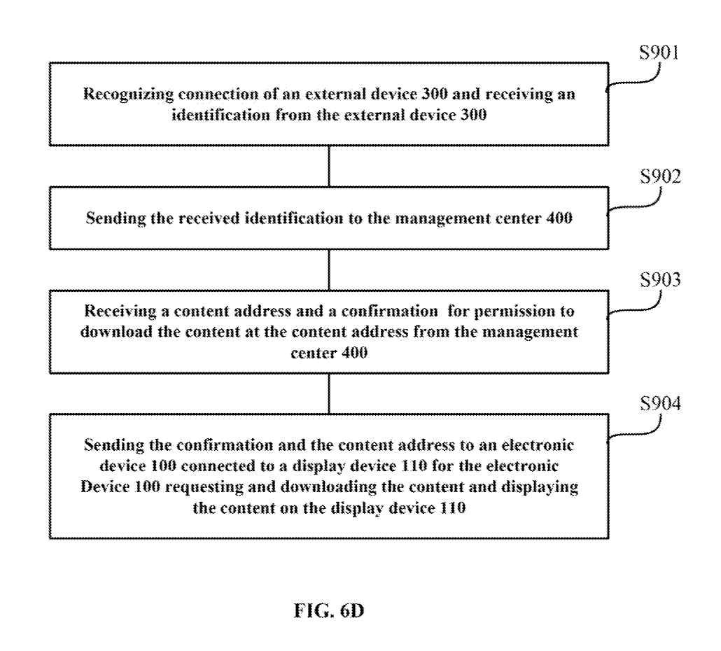

FIGS. 6A, 6B, 6C and 6D are flowcharts illustrating the method for receiving identification of content/service, verifying the identification by transmitting the identification to the management center 400 and receiving a confirmation and an address or an index for content/service, retrieving the content/service by the address or the index and outputting the content/service to the display device 110 according to one embodiment of the present invention. The method of the present invention may be applied on the electronic device 100, the portable device 200 and/or the management center 400 of the present invention respectively.

FIG. 6A illustrates the method for subscribing to new content/service by an identification received from the external device 300 and receiving the subscribed content/service according to one embodiment of the present invention, and the method of present invention may perform the following steps. In step S601, the portable device 200 may recognize connection of the external 300 and receive an identification corresponding to a new content/service from the external device 300. In step S602, the portable device 200 may send the identification to the management center 400 for verifying the identification. In step S603, the management center 400 may confirm the identification by comparing the identification to an identification database to decide whether the identification is valid. If the identification is valid, the management center 400 may return a confirmation to the portable device 200. In one embodiment, the confirmation may comprise an address or an index of the content/service for the electronic device 100 to download the content/service. In another embodiment, the aforementioned address or index of content/service may be contained in the identification instead of the confirmation, and the portable device 200 may be configured to request for downloading the content/service after receiving the confirmation. In step S604, the portable device 200 may send the confirmation and/or the identification to the electronic device 100 for the content/service corresponding to the identification. In step S605, the electronic device 100 may send the identification and/or the confirmation to content provider 500 for requesting for content/service corresponding to the identification by visiting the content/service address contained in the identification or the confirmation. In one embodiment of the present invention, the identification may tell the content provider 500 the content/service demanded from the electronic device 100, and the confirmation may be recognized by the content provider 500 for the content provider 500 to identify whether the identification is verified by the management center 400 and subscribed to the requested content/service. The content provider 500 may receive the identification and/or the confirmation and provide the corresponding content/service for downloading. In step S606, the electronic device 100 may download the content/service from the content provider 500 and transmit the downloaded content/service to the display device 100 for displaying the content/service.

In one embodiment of the present invention, the content provider 500 may be continuously providing the aforementioned content/service to the electronic device 100 while the external device 300 connected to the portable device 200. Once the external device 300 disconnected with the portable device 200, the portable device may send a notification to the electronic device 100, and the electronic device 100 may stop downloading the content/service from the content provider 500.

FIG. 6B illustrates the method for subscribing to new content/service by an identification received from the portable device 200 and receiving the subscribed content/service according to one embodiment of the present invention. The method of the present invention may be applied on the electronic device 100, and may perform the following steps. In step S701, the electronic device 100 may receive a confirmation and a content address corresponding to a new content/service from a portable device 200. The confirmation and the content address may be generated in the management center 400 after the management center 400 verifying a received identification corresponding to the content/service from the portable device 200. The identification may be stored in an external device 300 connected to the portable device 200. The identification may also be encoded in an automatic identification symbol 800 and extracted by the portable device 200. The identification may further be downloaded for an identification source 700 by the portable device 200. The confirmation may give the electronic device 100 permission to download the corresponding content/service at the content address. In step S702, the electronic device 100 may send the confirmation to the content address and may request for the content/service. In step S703, the electronic device 100 may download the content/service from the content address and display the content on the display device 110.

FIG. 6C illustrates the method for providing subscription of new content/service by an identification and providing the subscribed content/service according to one embodiment of the present invention. The method of the present invention may be applied on the management center/content provider 600, and may perform the following steps. In step S801, the management center/content provider 600 may receive an identification for new content/service form the portable device 200. The received identification may be retrieved from the external device 300. In step S802, the management center/content provider 600 may confirm the identification. In one embodiment, the management center/content provider 600 may maintain a database of identifications for comparing to the received identification to determine whether the received identification is valid. In addition, the management center/content provider 600 may further record subscription of the identification and check whether received identifications have already been subscribed to avoid repeated subscription. The management center/content provider 600 may send a confirmation to the portable device 200 if the identification is valid and/or not repeatedly subscribed. The confirmation may be recognized by the electronic device 100 for the permission to download the content/service corresponding to the identification. The portable device 200 may further send the confirmation and the identification to the electronic device 100, and the electronic device 100 may be configured to send the confirmation to the management center/content provider 600. In step S803, the management center/content provider 600 may receive the confirmation from the electronic device 100, and which is transmitted from the portable device 200 to the electronic device. In step S804, the management center/content provider 600 may transmit the content/service corresponding to the identification to the electronic device 100 for displaying the content/service on the display device 110 connected to the electronic device 100.

FIG. 6D illustrates the method for receiving identification of content/service from the external device 300 and subscribing to the content/service according to one embodiment of the present invention. The method of the present invention may be applied on the portable device 200, and may perform the following steps. In step S901, the portable device 200 may recognize connection of the external 300 and receive an identification corresponding to a new content/service from the external device 300. In step S902, the portable device 200 may send the identification to the management center 400 for subscribing to the content/service. In step S903, the portable device may receive a content address and a confirmation for permission to download the content at the content address form the management center 400. In step S904, the portable device may send the confirmation and the content address the electronic device 100 for the electronic device requesting and downloading the content/service and displaying the content/service on the display device 110.

The electronic device 100 may send the identification to the management center 400 and may receive the content information from the management center 400. The content information may comprise the name and the address of the content. The electronic device 100 may provide the received content information and a user interface for inputting content index to the user of the portable device 200 by displaying the content information and the user interface on the display device 110. In step S403, the portable device 200 may receive a content index from the user, which is assigned to the content/service corresponding to the identification by the user. The aforementioned content index may comprise numbers and/or characters, especially a number represent a TV channel when the electronic device 100 or the display device 110 is a television. In step S404, the portable device 200 may send the content index to the electronic device 100 for assigning the content index to the content/service corresponding to the identification. The electronic device 100 may record the content index and the content address and may access the content/service by the content address or provide the content/service every time the electronic device 100 receives the content index.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

What is claimed is:

1. An electronic assembly for providing content from a content provider, wherein the electronic assembly is configured to provide attachment to an object, the electronic assembly comprising:
an attachment mechanism providing attachment to the object;
a storage module assembled with the attachment mechanism, wherein the storage module corresponding to the content provided by the content provider;
a wireless communication module assembled with the attachment mechanism, wherein the wireless communication module is configured to transmit the identification to a first electronic device when the first electronic device is communicable connected with the wireless communication module;
wherein the first electronic device is configured to send the identification to a management center and provide the identification to a second electronic device; and
wherein the second electronic device is configured to obtain from the management center a confirmation corresponding to the identification, send the confirmation to the content provider, obtain the content from the content provider and output the content.

2. The electronic assembly according to claim 1, wherein the first electronic device sends the identification to the management center by providing the identification to the second electronic device, and the second electronic device further sends the identification to the management center.

3. The electronic assembly according to claim 1, wherein the second electronic device further receives the confirmation from the management center after sending the identification to the management center, and the second electronic device obtains the confirmation from the management center by receiving the identification from the first electronic device.

4. The electronic assembly according to claim 1, wherein the identification comprises an entity code reproducibly identifying the content provider and a content code reproducibly identifying the content.

5. The electronic assembly according to claim 1, wherein the first electronic device and the second electronic device is the same device.

6. The electronic assembly according to claim 1, wherein the wireless communication module is selected from a wireless personal area network module, a near field communication module or a radio frequency identification module.

7. A method for providing content from a content provider, the method being implemented in a first electronic device, the method comprising:
obtaining an identification corresponding to the content from a second electronic device, wherein the second electronic device provides the identification to the first electronic device in response to receiving the identification from a third electronic device storing the identification;
obtaining a confirmation corresponding to the identification from a management center, wherein the management center generates the confirmation in response to receiving the identification;
sending the confirmation to the content provider to request for the content; and
obtaining the content from the content provider and transmitting the content to an output device.

8. The method according to claim 7, further comprising:
sending the identification to the management center to obtain the confirmation corresponding to the identification from the management center.

9. The method according to claim 7, wherein the second electronic device further sends the identification to the management center for the management center generating the confirmation, and the management center sends the confirmation to the first electronic device via the second electronic device.

10. The method according to claim 7, further comprising:
generating a user interface for receiving a channel index representing the content and transmitting the user interface to the output device;
receiving a value and assigning the value to the channel index representing the content; and
wherein the first electronic retrieves and output the content in response to receiving the value as the channel index representing the content.

11. A system for providing content related to an object from a content provider, the system being implemented in a first electronic device, the system comprising:
an identification receiver for obtaining an identification corresponding to the content, wherein the identification stored in an electronic assembly attached to the object;
a confirmation obtainer for obtaining a confirmation corresponding to the identification from a management center, wherein the management center generates the confirmation in response to receiving the identification;
a content requester for sending the confirmation to the content provider to requesting for the content, obtaining the content from the content provider; and
a content presenter for transmitting the content to an output device.

12. The system according to claim 11, wherein the confirmation obtainer further sends the identification to the management center to obtain the confirmation corresponding to the identification from the management center.

13. The system according to claim 11, wherein the identification receiver obtains the identification from a second electronic device which receives the identification from the electronic assembly, and wherein the second electronic device further sends the identification to the management center for the management center generating the confirmation to be obtained by the confirmation obtainer.

14. The system according to claim 11, further comprising:
a channel index assigner for generating a user interface to receive a channel index representing the content and receiving a value to be assigned to the channel index representing the content; and
a content selector for retrieving the content in response to receiving the value as the channel index representing the content.

15. An electronic device for providing content from a content provider, comprising:
a first communication module;
a second communication module;
an output interface;
at least one processor electrically coupled to the first communication module, the second communication module and the output module; and
a memory including instructions that, when executed by the at least one processor, cause the electronic device to:
obtain an identification corresponding to the content by the first communication module;
obtain a confirmation corresponding to the identification from a management center by the second communication module, wherein the management center generates the confirmation in response to receiving the identification;
send the confirmation to the content provider to request for the content and obtain the content from the content provider by the second communication module; and
transmit the content to an output device by the output interface.

16. The electronic device according to claim 15, wherein the memory further includes instructions that, when executed by the at least one processor, cause the electronic device to send the identification to the management center by the second communication module for obtaining the confirmation from the management center.

17. The electronic device according to claim 15, wherein the memory further includes instructions that, when executed by the at least one processor, cause the electronic device to:
generate a user interface for receiving a channel index representing the content and transmit the user interface to the output device;
receive a value and assign the value to the channel index representing the content; and
retrieve and output the content in response to receiving the value as the channel index representing the content.

18. The electronic device according to claim 15, wherein the identification is stored in an electronic assembly attached to an object, and the electronic device obtains the identification from the electronic assembly, and wherein the content is related to the object.

19. A system for providing content from a content provider, the system being implemented in a first electronic device, the system comprising:
an identification obtainer for obtaining an identification corresponding to the content from an automatic identification symbol;
a confirmation obtainer for sending the identification to a management center and receiving a confirmation from the management center; and
a content requester for providing the confirmation to the content provider to request the content.

20. The system according to claim 19, wherein the content requester requests the content by providing the confirmation to a second electronic device, and the second electronic device is configured to request and obtain the content from the content provider by the confirmation.

21. The system according to claim 19, further comprising an application launcher for launching a computer program to process the content.

22. The system according to claim 19, further comprising:
a channel index assigner for generating a user interface to receive a channel index representing the content and receiving a value to be assigned to the channel index representing the content; and
a content selector for retrieving the content in response to receiving the value as the channel index representing the content.

23. A system for providing content from a content provider, the system being implemented in a first electronic device, the system comprising:
an identification obtainer for obtaining an identification corresponding to the content from an external device;
a identification forwarder for sending the identification to a second electronic device for the second electronic device to request and receive a confirmation from a management center by the identification; and
wherein the second electronic device requests and obtains the content from the content provider by the confirmation.

24. The system according to claim 23, wherein the identification comprises an entity code for the second electronic device reproducibly identifying the content provider and a content code for the second electronic device reproducibly identifying the content.

25. The system according to claim 23, wherein the external device is attached to an object, and wherein the content is related to the object.

26. An electronic device for providing content from a content provider, comprising:
a communication module;
an automatic identification sensor;
an output interface;
at least one processor electrically coupled to the first communication module, the second communication module and the output module; and
a memory including instructions that, when executed by the at least one processor, cause the electronic device to:
obtain an identification corresponding to the content by the automatic identification sensor from an automatic identification symbol;
send the identification by the communication module to a content retrieval device for the second electronic device to request and receive a confirmation from a management center by the identification; and
wherein the content retrieval device requests and obtains the content from the content provider by the confirmation.

27. The electronic device according to claim 26, wherein the identification comprises an entity code for the content retrieval device reproducibly identifying the content provider and a content code for the content retrieval device reproducibly identifying the content.

28. The electronic device according to claim 26, wherein the automatic identification symbol is attached to an object, and wherein the content is related to the object.

29. The electronic device according to claim 26, wherein automatic identification senor and the automatic identification symbol each comprises a wireless communication module respectively for transmitting the identification from the automatic identification symbol to the automatic identification sensor.

30. A method for providing content from a content provider, the method comprising:
receiving from an electronic device an identification corresponding to the content, wherein the first electronic device obtains the identification from an electronic assembly;
verifying whether identification is valid and generating a confirmation corresponding to the identification if the identification is valid, wherein the content provider recognizes the confirmation for permission to download the content; and
transmitting the confirmation to the electronic device.

31. The method according to claim 30, wherein the electronic assembly is attached to an object, and the content is related to the object.

32. The method according to claim 30, wherein the confirmation comprises a content address corresponding to the content provided by the content provider for a computer receiving the confirmation to visit and download the content from the content provider.
